(19) United States
(12) Patent Application Publication
(10) Pub. No.: US 2011/0282507 A1
(43) Pub. Date: Nov. 17, 2011

(54) METHOD AND APPARATUS FOR ADAPTING AT LEAST ONE SET OF PARAMETERS OF AN INTELLIGENT ELECTRONIC DEVICE

(75) Inventors: Alexandre OUDALOV, Fislisbach (CH); Otmar GOERLITZ, Fislisbach (CH); Thomas KOCH, Zurich (CH); Yan ZHANG, Baden (CH); Christian FREI, Fislisbach (CH)

(73) Assignee: ABB RESEARCH LTD, Zurich (CH)

(21) Appl. No.: 13/151,979

(22) Filed: Jun. 2, 2011

Related U.S. Application Data
(63) Continuation of application No. PCT/EP2009/066384, filed on Dec. 3, 2009.

(30) Foreign Application Priority Data
Dec. 3, 2008 (EP) 08170550.1

(51) Int. Cl. G06F 1/28

(52) U.S. Cl. 700/292

(57) ABSTRACT

The disclosure concerns a method and an apparatus for adapting at least one set of parameters to at least one Intelligent Electronic Device (IED) of an electrical power network having a plurality of switching devices (CB). The method includes: a) reading the current network status of the electrical power network, wherein the network status includes the status of the plurality of switching devices; b) simulating at least one network fault in the electrical power network; c) deducing at least one new set of parameters for the at least one IED using a simulated fault current induced by the at least one simulated network fault under consideration of the present network status and the network topology of the electrical power network; and d) setting the at least one set of parameters in at least one of the at least one IED. The apparatus a) reads the current network status of the electrical power network, b) selects the at least one set of parameters for the at least one Intelligent Electronic Device out of a plurality of sets of parameters depending of the current network status; and c) sets the at least one set of parameters in the at least one IED.

### RELATED APPLICATION

This application claims priority as a continuation under 35 U.S.C. §120 to PCT/EP2009/066384 filed on Dec. 3, 2009 designating the U.S., and under 35 U.S.C. §119 to EP 08170550.1 filed on Dec. 12, 2008, the entire contents of which are hereby incorporated by reference in their entireties.

### FIELD

The present disclosure relates to a method for applying at least one set of parameters to at least one Intelligent Electronic Device (IED) of an electrical power network having a plurality of switching devices. The present disclosure also relates to an apparatus configured to apply at least one set of parameters to at least one IED of an electrical power network having a plurality of switching devices.

### BACKGROUND INFORMATION

A power network is protected from failures (e.g., short-circuits) through the use of Intelligent Electronic Devices (IEDs). The protection functions in an IED have been standardized, for example, in an IEEE/ANSI standard and are available in IEC 61850, for example, as logical nodes.

The aim of every protective setting is to achieve selectivity, e.g., a protection relay closest to a fault location (e.g., upstream in case of radial networks) trips a circuit breaker. All other relays may detect the fault but do not switch off or at least only after a predefined delay. This ensures backup protection if regular protection fails.

Parameters of a protection function may be defined at engineering time for a given power network state. However, this state may change over time and thus protection parameters should be adapted. In some cases, engineering does take that into account by defining setting groups for different network states (e.g., summer/winter settings). For instance, a setting group can define a set of values for protection functions. It is then the responsibility of an operator or a protection engineer at the utility to set the correct active setting group.

With the introduction of microprocessor based relays, it has been proposed to use the new processing capabilities and programmability of the relays to adjust the behavior of the protection system during operation. Until then, a protection system was designed and implemented with an unchangeable behavior, embodied in various parameters of the relays. The protection engineer designed the system so that it would respond correctly to all contingencies in a power system conceivable at design time. However, since the protection system may respond correctly in a wide variety of different situations, often this behavior compromises fault selectivity and network availability in favor of reliability.

In contrast, computer based relays allow a change of their characteristics even after they have been installed in a power system.

While there are a number of ideas proposed, the most notable realization of relay setting adaptation are setting groups. Digital relays have the capacity to store several sets of parameters controlling its behavior under different system conditions. The settings are defined and uploaded to the relay at engineering time. During operation, the human operator can switch the active setting group by sending a control signal to the relay. The decision when and to which group to switch rests still with the operator.

Further, one of the major challenges is a protection system for a microgrid which may respond to both main grid and microgrid faults, where the microgrid is connected to the main grid. In a first case, the protection system may isolate the microgrid from the main grid as rapidly as necessary to protect the microgrid loads. In a second case, the protection system may isolate the smallest part of the microgrid when it clears the fault. A segmentation of microgrid, e.g., a creation of multiple islands or sub-microgrids, may be supported by micro-source and load controllers. In these circumstances, problems related to selectivity (e.g., false, unnecessary tripping) and sensitivity (e.g., undetected faults or delayed tripping) of protection system may arise. For instance, it was seen that a large difference between fault currents in main grid connected and islanded modes may create errors in the protections of microgrids. A microgrid protection system may have a high sensitivity to faults and selectivity to isolate/sectionalize microgrid especially in the case of distributed energy resources (DERs) with power electronics (PE) interfaces (low fault current levels).

A decision to either sectionalize the microgrid or shut it down in case of fault will depend on the needs of microgrid customers and whether a cost involved (protection and communication) could be justified for benefits gained by a sectionalizing (e.g., reduced end-consumer interruption time).

Operating conditions of a microgrid are constantly changing because of the intermittent micro-sources (wind and solar) and periodic load variation. Moreover, the directions and amplitudes of short circuit currents will also vary. Furthermore, a network topology may be regularly changed to achieve loss minimization or other economic or operational targets. In addition, controllable islands of different sizes and content may be formed as a result of faults in the main grid or inside a microgrid.

In such circumstances, a loss of relay coordination may happen and generic over-current (OC) protection with a single setting group may become inadequate, e.g., it will not guarantee a selective operation for all possible faults. Therefore, it is desirable to ensure that the settings chosen for OC protection relays take into account a grid topology and changes in location, type and amount of generation. Otherwise, unwanted operation or failure to operate when required may occur.

In order to cope with bi-directional power flows and low short-circuit current levels in microgrids dominated by micro-sources with power electronic interfaces, a new protection philosophy is desirable, where setting parameters of relays may be checked/updated periodically to ensure that they are still appropriate.

### SUMMARY

An exemplary embodiment of the present disclosure provides a method for adapting at least one set of parameters of at least one Intelligent Electronic Device (IED) of an electrical power network having a plurality of switching devices. The method includes: a) reading a present network status of the electrical power network, the present network status including a present status of the plurality of switching devices; b) deducing, in a processor of a computer processing device, at least one new set of parameter values for the at least one IED based on a simulated fault current induced by at least one simulated network fault under consideration of the present network status and a network topology of the electrical power network; and c) applying the at least one new set of parameter values to the at least one set of parameters of the at least one IED.

An exemplary embodiment of the present disclosure provides an apparatus for adapting at least one set of parameters of at least one Intelligent Electronic Device (IED) of an electrical power network having a plurality of switching devices. The apparatus includes a calculation unit configured to simulate at least one network fault in the electrical power network and to deduce at least one set of parameter values for the at least one IED based on a simulated fault current induced by the at least one simulated network fault under consideration of a network status and a network topology of the electrical power network. The apparatus includes a determining unit configured to determine a present network status of the electrical power network, the network status including a status of the plurality of switching devices. The calculating unit is configured to deduce a new set of parameter values for the at least one IED depending on the present network status. The apparatus is configured to provide the new set of parameter values to the at least one IED for updating the at least one set of parameters of the at least one IED.

### BRIEF DESCRIPTION OF THE DRAWINGS

Additional refinements, advantages and features of the present disclosure are described in more detail below with reference to exemplary embodiments illustrated in the drawings, in which:

FIG. 1a shows a flow chart of a method for an offline calculation of parameters according to an exemplary embodiment of the present disclosure;

FIG. 1b shows a flow chart of a method using the parameters of an offline calculation according to an exemplary embodiment of the present disclosure;

FIG. 2 shows a flow chart of a method of an on-line calculation of parameters according to an exemplary embodiment of the present disclosure;

FIG. 3 depicts schematically a network according to an exemplary embodiment of the present disclosure;

FIG. 4 depicts schematically the network of FIG. 3 with a fault, according to an exemplary embodiment of the present disclosure;

FIG. 5 depicts schematically the network of FIG. 4 after a fault, according to an exemplary embodiment of the present disclosure;

FIG. 6 shows schematically a network according to an exemplary embodiment of the present disclosure;

FIG. 7 shows schematically the network of FIG. 6 with faults, according to an exemplary embodiment of the present disclosure;

FIG. 8 shows schematically the network of FIG. 6 with a microgrid central controller, according to an exemplary embodiment of the present disclosure;

FIG. 9 depicts schematically a local protection function inside a circuit breaker according to an exemplary embodiment of the present disclosure;

FIG. 10 depicts schematically a structure of an event table according to an exemplary embodiment of the present disclosure;

FIG. 11 shows schematically an embodiment of an microgrid protection and control architecture according to an exemplary embodiment of the present disclosure; and

FIG. 12 shows schematically phases of an on-line adaptive protection algorithm according to an exemplary embodiment of the present disclosure.

### DETAILED DESCRIPTION

Exemplary embodiments of the present disclosure provide an improved protection against faults in electrical power networks, including distributed energy resources, for example.

An exemplary embodiment of the present disclosure provides a method for adapting at least one set of parameters to at least one IED of an electrical power network having a plurality of switching devices. The exemplary method includes: a) reading (e.g., determining) the current network status of the electrical power network, wherein the network status includes the status of the plurality of switching devices; b) simulating at least one network fault in the electrical power network; c) deducing at least one new set of parameters for the at least one IED using simulated fault currents induced by the at least one simulated network fault under consideration of the current network status and the network topology of the electrical power network; and d) setting the at least one set of parameters in at least one of the at least one Intelligent Electronic Device.

In accordance with an exemplary embodiment, which may be combined with other embodiments described herein, in step c) the at least one new set of parameters is deduced under consideration of forecast information within a predefined horizon. The predefined horizon for the forecast information may be, for example, 0.5 h, 1 h, 6 h, 12 h or 24 h. In accordance with an exemplary embodiment, the forecast information includes information about the weather, the status of distributed energy resources, e.g. wind turbines, photovoltaic power plants, etc., and/or the future status of loads.

Exemplary embodiments of the present disclosure provide for the protection parameter settings of IEDs protecting a power network. Exemplary embodiments of the present disclosure seek to augment the capabilities of an IED to detect the need for protection setting adaptation and either inform a human operator of the need (for instance through an alarm) or to perform the parameter settings automatically and autonomously, with the ultimate goal to improve selectivity, sensitivity (e.g., relay must sense different faults and does not sense inrush currents) and speed (e.g., relay must react in the shortest possible time).

In accordance with an exemplary embodiment, the method according to the present disclosure addresses the following steps: detection of the need for adaptation of the protection settings as a Boolean function of variables describing the power network's state (e.g., position of switches). For instance, according to an exemplary embodiment, notification of the operator of the need to update the protection settings of one or more IEDs. Exemplary embodiments of the present disclosure also provide an automatic proposal of correct protection parameters—for example, to the operator. In accordance with an exemplary embodiment, an automatic (and autonomous) update of protection parameters by the IEDs (or a device which can communicate with the IEDs) is provided whenever the need for adaptation is detected.

In accordance with an exemplary embodiment, a method according to the present disclosure may be applied to the setting for over-current protection in radial networks, possibly including distributed generation.

In accordance with an exemplary embodiment, which may be combined with other embodiments described herein, the network topology includes low and medium voltage lines, connections between the plurality of switching devices and the like.

In accordance with an exemplary embodiment, the IED may control at least one switching device in the electrical power network, such as a current breaker, for example.

In accordance with an exemplary embodiment, which may be combined with other embodiments described herein, the set of parameters includes at least one parameter, such as a plurality of parameters.

In accordance with an exemplary embodiment, the parameters of the set of parameters may include the protection settings of the at least one IED, for example.

In accordance with an exemplary embodiment, which may be combined with other embodiments described herein, the parameters of the set of parameters include tripping voltage, tripping time, tripping conditions and/or tripping characteristics, for example.

In accordance with an exemplary embodiment, which may be combined with other embodiments described herein, a status of a switch device may include two states, such as an open switch state and a closed switch state, for example.

In accordance with an exemplary embodiment, which may be combined with other embodiments described herein, the simulated network faults may be located in the electrical power network. In accordance with an exemplary embodiment, the simulated network fault may be located in a load and/or a distributed energy resource, for example.

In accordance with an exemplary embodiment, faults in a distributed energy resource may be cleared by the device's protection (e.g., the generator protection). In accordance with an exemplary embodiment, faults on the load should be cleared by the load's protection (e.g., the main fuse at the houses connection to the electrical network).

In accordance with an exemplary embodiment, which may be combined with other embodiments described herein, the electrical power network may include more than two different IEDs, wherein at least two different IEDs have different sets of parameters.

In accordance with an exemplary embodiment, which may be combined with other embodiments described herein, the electric power network can be a medium voltage and/or low voltage distribution network, for example.

In accordance with an exemplary embodiment, which may be combined with other embodiments described herein, substantially all predictable network faults can be simulated.

In accordance with an exemplary embodiment, a network fault can include a short circuit, a load error, a lightning, and/or the like.

In accordance with an exemplary embodiment, which may be combined with other embodiments described herein, the network status may include discretized measurements and/or status values, e.g. current, voltage, distributed generation (DG) sources and the like.

An exemplary embodiment of the present disclosure provides a method for adapting at least one set of parameters to at least one IED of an electrical power network having a plurality of switching devices. The exemplary method includes: a) reading (e.g., determining) the current network status of the electrical power network, wherein the network status includes the status of the plurality of switching devices; b) selecting the at least one set of parameters for the at least one IED out of a plurality of sets of parameters depending of the current network status; and c) setting the at least one set of parameters in the at least one IED.

In accordance with an exemplary embodiment, the settings or the set of parameters may be pre-computed before the electrical power network is used.

In accordance with an exemplary embodiment, which may be combined with other embodiments described herein, in step b) the at least one new set of parameters are selected under consideration of forecast information within a predefined horizon. The predefined horizon for the forecast information may be, for example, 0.5 h, 1 h, 6 h, 12 h or 24 h. In accordance with an exemplary embodiment, the forecast information can include information about the weather, the status of distributed energy resources, e.g. wind turbines, photovoltaic power plants, etc., and/or the future status of loads.

According to an exemplary embodiment, the plurality of sets of parameters can be created by permuting through a plurality of network statuses, wherein for each network status i) at least one network fault is simulated in the electrical power network; and ii) at least one new set of parameters for the at least one IED is deduced under considerations of the at least one simulated network fault, the network status, and the network topology.

In accordance with an exemplary embodiment, which may be combined with other embodiments described herein, each network status is encoded into logic expressions, e.g., in Boolean expressions, such that the network status is represented by a vector comprising binary values.

In accordance with an exemplary embodiment, steps i) and ii) are created by permuting through substantially all network statuses.

In accordance with an exemplary embodiment, the method may also include creating a table and/or a database including the network statuses, for example, encoded in logic expressions, and the set of parameters corresponding to each network status in the table and/or the database.

In accordance with an exemplary embodiment, substantial only network statuses that have influence on the behavior of the protection system of the at least one IED may be stored in the table and/or the database.

In accordance with an exemplary embodiment, the table and/or the database are stored in the IED and/or a storing device in a substation, in a distribution region, in a network control center.

According to an exemplary embodiment, which may be combined with other embodiments described herein, after step a), the method includes: a1) encoding the actual network status into logic expressions, such as into Boolean expressions, such that the network status is represented by a vector comprising binary values.

In accordance with this embodiment, Boolean values simplify the deducing of the set of parameters and/or the selection of the set of parameters. Furthermore, in accordance with an exemplary embodiment, Boolean values may simplify the determination if relay or switch settings have to be adapted.

In accordance with an exemplary embodiment, steps a), b), c) and/or d) are performed after an event.

It may also be determined, for example, automatically, the necessity to adapt relay settings or the settings of an IED.

In accordance with an exemplary embodiment, an event may be, for example, a change of the network status, a change of weather, a change of time.

In accordance with an exemplary embodiment, the deducing of the at least one new set of parameters may include forecast information about future loads, future available energy resources, and the like. In accordance with an exemplary embodiment, the forecast may have a forecast time, wherein, for example, the setting of the at least one set of parameters in the at least one IED is applied approximately at the forecast time.

In accordance with an exemplary embodiment, an event may be the connection or disconnection of a distributed energy resource, a network topology change, e.g. into an islanded mode or into a connected mode.

Further, an event may include the change in the forecast of distributed generation (DG) levels.

In accordance with an exemplary embodiment, which may be combined with further embodiments described herein, a system state or the network status may be sent only on change, for example, if the network status is discretized, via a communication infrastructure, for example. The network status may be sent via GOOSE messages of IEC 61850, for example.

In accordance with an exemplary embodiment, step a) is performed periodically.

In accordance with an exemplary embodiment, which may be combined with other embodiments described herein, steps b), c) and/or d) may be only performed if the actual network state differs from the previous network state.

In accordance with an exemplary embodiment, the set of parameters of the at least one IED can only be set, if the at least one parameters differs from the actual at least one parameter.

In accordance with an exemplary embodiment, the relay settings and/or the set of parameters can only be sent to the affected relay or IED. Thus, the quantity of communication messages may be reduced.

In accordance with an exemplary embodiment, the network status includes the position of all switches.

According to an exemplary embodiment, the network status includes the status of a distributed energy resource connected to the electrical power network and/or the status of a load connected to the electrical power network.

In accordance with an exemplary embodiment, distributed energy resources may be a Diesel generator, a Photovoltaic energy source and/or wind energy source, for example.

In accordance with an exemplary embodiment, which may be combined with other embodiments described herein, the set of parameters can be applied to the IED automatically.

An exemplary embodiment of the present disclosure also provides an apparatus configured to adapt at least one set of parameters to at least one IED of an electrical power network having a plurality of switching devices. The apparatus is configured to receive and/or determine the current network status of the electrical power network, wherein the network status includes the status of the plurality of switching devices. The apparatus includes a calculation unit configured to simulate at least one network fault in the electrical power network and to deduce at least one new set of parameters for the at least one IED using a simulated fault current induced by the at least one simulated network fault under considerations of the current network status and the network topology of the electrical power network. The apparatus provides the set of parameters to the at least one IED for updating the parameters of the IED.

In accordance with an exemplary embodiment, a self-adapting protection IED is provided.

An exemplary embodiment of the present disclosure provides an apparatus configured to adapt at least one set of parameters to at least one IED of an electrical power network having a plurality of switching devices is provided. The apparatus is configured to receive and/or determine the current network status of the electrical power network, wherein the network status includes the status of the plurality of switching devices. The apparatus includes a calculation unit configured to select the at least one set of parameters for the at least one IED out of a plurality of sets of parameters depending of the current network status. The apparatus provides the set of parameters to the at least one IED for updating the at least one IED.

In accordance with an exemplary embodiment, which may be combined with other embodiments described herein, the network status can be encoded into logic expressions, e.g., into Boolean expressions, such that the network status may be represented by a vector comprising binary values.

In accordance with an exemplary embodiment, the apparatus is configured to create the plurality of sets of parameters by permuting through a plurality of network status, wherein for each network status i) at least one network fault is simulated; and ii) at least one new set of parameters for the at least one IED is deduced using a simulated fault current induced by the at least one simulated network fault under considerations of the network status and the network topology.

In accordance with an exemplary embodiment, the electric power network include radial networks, meshed networks, over current and directional over-current relays, in networks with or without distributed generators (DG), for example.

In accordance with an exemplary embodiment, which may be combined with other embodiments described herein, the network status may be collected at a central computer, for example, in a substation, in a region, in a network control center, and/or in an IED.

In accordance with an exemplary embodiment, the apparatus is an IED or a relay.

The features of the method and apparatus as described herein may be performed by way of hardware components, firmware, and/or a computer having a processor programmed by appropriate software, by any combination thereof or in any other manner. For instance, exemplary embodiments of the present disclosure provide a non-transitory computer-readable recording medium (e.g., ROM, hard disk drive, optical memory, flash memory, etc.) on which a computer program is recorded that causes a processor a computer processing device (e.g., a CPU) to carry out any of the features described herein. For example, the apparatus (e.g., substation, network control center, IED, relay, etc.) can include such a processor for implementing the features described herein, including the exemplary features of the method as described herein.

In accordance with an exemplary embodiment, the network status may be collected in each relay or IED.

In accordance with an exemplary embodiment, the affected relay or IED activates the settings or the set of parameters without further coordination with other relays. Thus, even an activation of new settings in only a few relays cannot worsen the behavior of the protection system.

In accordance with an exemplary embodiment, an electrical network communication infrastructure may be provided between IEDs.

In accordance with an exemplary embodiment, if one relay or IED is not able to determine new settings it may obtain new settings or a set of parameters from any other relay via communication infrastructure. In accordance with an exemplary embodiment, which may be combined with other embodiments, a first relay or a first IED may send a request after a specific time delay and/or as result of its performance check by neighboring devices to a second relay and/or a second IED.

In accordance with an exemplary embodiment, each relay or IED calculates or deduces the new set of parameters. Then, the IED has the settings or set of parameters ready. In accordance with an exemplary embodiment, the IED or relay calculates or deduces the new set of parameters on request, in particular of a substation, a network control center and/or another IED or relay.

In accordance with an exemplary embodiment, in an electric power network with at least two relays or IEDs, one of these IEDs may calculate or deduce the set of parameters or settings for other IEDs or relays. For instance, the calculating or deducing relay or IED may act as primus inter pares and may be responsible for the calculations or as back-up scheme in case a relay fails to execute the calculations.

Further advantages, features, aspects and details are evident from the following description of exemplary embodiments and the drawings.

Exemplary embodiments are also directed to apparatuses for carrying out the disclosed methods and including apparatus parts for performing described method steps. Furthermore, embodiments are also directed to methods by which the described apparatus operates or by which the described apparatus is manufactured. It may include method steps for carrying out functions of the apparatus or manufacturing parts of the apparatus. As described above, the features of the method and apparatus as described herein may be performed by way of hardware components, firmware, and/or a computer having a processor programmed by appropriate software, by any combination thereof or in any other manner.

Thus, the capabilities of an IED are augmented to detect the need for protection setting adaptation and either inform a human operator of the need (for instance, through an alarm) or to perform the parameter settings automatically and/or autonomously. Thus, the selectivity, sensitivity (e.g., relay may sense different faults and does not sense inrush currents) and/or speed (e.g., relay may react in the shortest possible time) of an IED are improved.

Exemplary embodiments of the present disclosure are based on an adaptation of protection relay settings with regard to a microgrid state (e.g., topology, generation and load).

In accordance with an exemplary embodiment, the following definitions may be used: Adaptive Protection: An on-line activity that modifies the preferred protective response to a change in system conditions or requirements. It is usually automatic, but can include timely human intervention. Adaptive Relay: A relay that can have its settings, characteristics or logic functions changed on-line in a timely manner by means of externally generated signals or control action.

Generally, the goal of adaptive protection is not to re-establish correct or reliable behavior of the protection system after a change in the power system, since the initial settings will normally protect the system under all circumstances. Instead, the adaptation aims at improving selectivity, avoiding nuisance trips, etc., and thus increases the availability of the network.

In accordance with exemplary embodiments of the present disclosure, adaptive protection may be categorized by their technical approach:

Include additional measurements, e.g. load or fault characteristics, in the relays calculations and tripping logic.

Communicate system state information, e.g. switch positions, to the relay and use the information in the tripping logic.

Analyze the system state (off-line) and check relay settings against the current system state; modify settings and upload to the relay, if necessary.

It is contemplated that elements of one embodiment may be advantageously utilized in other embodiments without further recitation.

Power systems currently undergo considerable change in operating requirements—mainly as a result of deregulation and due to an increasing amount of distributed energy resources (DER). In many cases, DER include different technologies that allow generation in small scale (micro-sources) and some of them take advantage of renewable energy resources (RES) such as solar, wind or hydro energy, for example. Having micro-sources close to a load provides the advantage of reducing transmission losses as well as preventing network congestions. Moreover, the chance of having a power supply interruption of end-customers connected to a low voltage (LV) distribution grid is diminished since adjacent micro-sources, controllable loads and energy storage systems may operate in an islanded mode in case of severe system disturbances (in fact a power delivery can be fully independent of the state of the main grid). In accordance with an exemplary embodiment, this is known as a microgrid.

Microgrids offer various advantages to end-consumers, utilities and society, such as:

improved energy efficiency,

minimized overall energy consumption,

reduced greenhouse gases and pollutant emissions,

improved service quality and reliability, and

cost efficient electricity infrastructure replacement.

For the general description of the following exemplary embodiments, it may be assumed that there is a substation automation system in place, or at least a communication infrastructure between IEDs, e.g. such as one based on IEC 61850. Also, it may be assumed that a network in which the main protection system includes over-current (OC) relays. In case there are distributed energy resources (DER) connected to the network, the main protection system can include directional over-current relays.

In accordance with an exemplary embodiment, which may be combined with other embodiments, an IED is a microprocessor based controller of power system equipment, e.g. for circuit breakers, relays, transformers and/or capacitor banks. An IED may receive data from at least one sensor and power equipment. Further, an IED may issue commands, such as tripping circuit breakers if they sense voltage, current, or frequency anomalies, or raise or lower voltage levels in order to maintain the desired level. In accordance with an exemplary embodiment, an IED can include around 5 to 12 protection functions, 5 to 8 control function for controlling separate devices. Further, an IED may include communication functions.

In accordance with an exemplary embodiment, the status of the power system with respect to topology can be represented by analyzing the network's base topology and the current position of substantially all switches. This information may be mapped in an exemplary embodiment which may be combined with other embodiments to clauses of Boolean logic. The logical formulas, in turn, may correspond to relay settings appropriate for the particular network state. Hence, settings for the (directional) OC relays may be obtained by using the switch state information as input for evaluating the Boolean formulas. In other embodiments, other types of logic may be used to map the network status.

In accordance with an exemplary embodiment, the network status may include only the status of substantially all switches, the status of loads and/or the status of distributed energy resources. Then, the topology of the network may be stored separately and/or deduced from the network status and a base topology, representing the schematically all positions of network elements and network nodes and the like.

In accordance with an exemplary embodiment, the term relay is used synonymously to an IED. In accordance with an exemplary embodiment, an intelligent electronic device may include a relay.

Two exemplary embodiments of the method for deriving the relay settings for a particular network state may be possible:

In a first embodiment of the method, all possible settings can be pre-computed. The Boolean formula is then used as index to select the appropriate settings. For instance, this embodiment for deriving the relay settings may be applied when the network has relatively small number of possible states. That means that all states of the may be calculated before the network is installed or connected.

In a second embodiment of the method, relay settings may be computed on-line, that means, for example, in case that a position of a switch has been changed. A processing unit programmed to implement an algorithm for determining correct relay settings will then take as input the same Boolean network representation. In this case, rules for calculating relay settings, which in the first case were used during engineering time, are embodied in the algorithm and can be executed any time during network operation.

In the two exemplary embodiments depicted above, the information about network state may be augmented by using, in addition to switch state, measurements or other information available. For example, information about the generation level of distributed energy resources (DER) may be useful to obtain a more precise network state representation. This information may be discretized, so it may be used to augment the original clauses of Boolean logic.

In accordance with an exemplary embodiment, it is also possible to incorporate forecasts (e.g., for DER generation levels, such as forecasts depending on weather conditions or similar, and/or loads). Again, the information may be used to augment the Boolean formulas or other logic formulas, so the above stated two mechanisms may be applied.

In accordance with an exemplary embodiment, which may be combined with other embodiments described herein, the system state information or network status information, e.g., switch positions, and/or discretized augmenting information as described above, may be sent periodically or on change via a communication infrastructure of the substation automation system.

According to an exemplary embodiment, the need to adapt protection parameters of an IED controlling, for example, a circuit breaker may be detected.

In addition to other means that may detect the necessity to update the relays' parameters, the above described evaluation of Boolean or other logic formulas may yield this information. Using the described methods appropriate relay settings for the current network state may be obtained. These settings may be compared to currently active relay settings. In accordance with an exemplary embodiment, in case of a difference, the relay settings may be changed.

When incorporating forecast information, as described above for an embodiment, a triggering of parameter adaptation may also be time-dependent. The forecast may define, in accordance with an exemplary embodiment, the time when the predicted conditions are assumed to become reality, or a defined time before they become reality, e.g. 0.5 h, 1 h, 12 h or 24 h before they become reality. Hence, adaptation of relay parameters may be triggered at a certain point in time. In accordance with an exemplary embodiment, to accommodate for possible deviations from predictions, a check of actual network state, and possibly again corrective action may be performed.

The functionality defining the need for protection setting adaptation may be set up in the same manner as for topology-based inter-locking rules. In an exemplary embodiment, IEC 61850 is used, such that amounts to configure each IED to listen to specific GOOSE messages sent by other IEDs informing them, for example, on the position of relevant switches for them to decide upon the need for protection setting reconfiguration, in the same manner as control interlocking (CILO) logical nodes are using the input of other (relevant) switches' position to determine if a switch can be opened or closed with respect to inter-locking rules. In accordance with an exemplary embodiment, the relevant switches and other information such as power flow direction, if necessary, may be determined at engineering time, for example, in a similar way as it is done for inter-locking.

Note that a change in network state and/or topology may require adaptation of the parameters of several protection functions and thus may impact, for example, independently, several IEDs or relays.

In accordance with an exemplary embodiment, once the need for re-configuration has been identified, the operator may be notified through appropriate means, e.g. by an alert on a monitor and/or through a dedicated alarm message of the underlying communication technology. It is then a human's (e.g., the operator's or the protection engineer's) responsibility to take action, either by selecting and adequate setting group or by changing the protection parameters in the IED(s). In accordance with an exemplary embodiment which may be combined with other embodiments described herein, protection parameters may be adapted automatically if no human intervention is desired as described in the next section.

In accordance with an exemplary embodiment, the detection of the need for re-configuration of the protection parameters may also be taken over by another computing device (or master) that is able to communicate with the IEDs, such as a station computer in the substation or a gateway. The same method then applies to that computing device, and it may replace the detection method for all IEDs it can communicate with.

The detection of the need for re-configuration of the protection parameters can be performed either whenever one input to the Boolean formulas or other suitable logical formulas change (event-based), and/or, periodically. In accordance with an exemplary embodiment, in order to avoid unnecessary computation and/or (operator) notification, a pre-set delay may be used so that multiple consecutive changes are treated “as one”.

In the following, the automatic update of protection settings of a relay for a circuit breaker or a switch is described.

In accordance with an exemplary embodiment, once the need for re-configuration has been identified, the relevant protection parameters may be updated automatically by the IED(s). Four alternative cases may apply which may be, in some embodiments, combined with each other:

1. The protection parameters for each possible network state is pre-computed during engineering time and saved in the IEDs. Then, Boolean logic on relevant switches and possibly other discrete (or discretized) criteria may be used to identify the corresponding network state and thus the protection parameters to apply, which can then be set independently by the IED(s). In one exemplary embodiment, the concept of setting groups may be used to store the different sets of parameters corresponding to the relevant network states, provided the IED(s) offer enough of them. This case is especially applicable when the number of possible cases (e.g., network states with different settings) are not too numerous (e.g., the impact on processing power is low).

2. In another exemplary embodiment, the protection parameters may be recomputed independently by each affected IED in a similar fashion than it is done during engineering for case 1. The algorithm for determining relay settings may be location independent, e.g., each relay may use the same algorithm with the same input information, such as a representation of the network status, for example. Protection parameters are then set independently in each IED (provided they are different than the ones in use). In this embodiment, which may be combined with other embodiments, the parameter settings may be computed automatically without human intervention and the IED(s) have the processing power to run such an algorithm.

3. In a further exemplary embodiment, another computing device (or master) that can communicate with all the IEDs (e.g., a station computer in the substation, a gateway, or even one of the relays) takes over the detection of the need for re-configuration of the protection functions. The same computing device then determines the parameters to use in the current network state, either using pre-computed tables (in a similar fashion than described in case 1), or by using a dedicated algorithm (in a similar fashion than described in case 2). The modified protection parameters are then uploaded to all IEDs by the master.

4. A variation of the embodiment of case 3 is when the network state change requires to re-configure the protection parameters running in IEDs that are not directly connected (communication-wise) to a same computing device (or master). In such a case, every master may perform the protection parameter update independently in its domain (where the domain is the set of all IEDs it can communicate with directly).

In accordance with an exemplary embodiment, neither of the above four cases for updating the relay settings requires transactional behavior in the update process, such as in order to ensure that all protection functions that need to be adapted are indeed done so, furthermore at the same time. For instance, in accordance with an exemplary embodiment, it is not enforced that all or none of the affected relays update their parameters. Hence, in this embodiment, no “Commit” or “Revert Back” logic is required. The “Commit” or “Revert Back” logic can refer to transactional behavior. If a number of settings are applied or if new settings are applied to a number of devices, transactional behavior would ensure “all or none”. If all settings applied correctly, the change is committed and it is valid from this moment. If any single application of a new value failed, then the IED may revert back to the previous state and all the new settings are discarded. This is generally also known as “rollback”. In accordance with an exemplary embodiment, the “commit” or “Revert Back” logic, i.e. “all or nothing”, in the transactional behavior may be not required. For example, the protection system does not deteriorate of some of a group of relays could not successfully apply new settings. This means, in particular, that there is no need to enforce a co-ordination among the relay with respect to the update of their parameters.

In accordance with an exemplary embodiment, the algorithm that determines the correct relay settings (at design time or on-line) ensures that the behavior of the protection system is not compromised if one relay fails to update its parameters. In case where several over-current protection functions (e.g., running possibly on different IEDs) need to have their parameters updated, even if one does not have its settings adapted the selectivity and/or sensitivity will be improved, compared to the situation where no parameter at all is adapted.

In accordance with an exemplary embodiment, the need for automatic updates can be triggered either event-based (e.g., whenever a relevant switch's position changes) or periodically. For example, a pre-set delay can be introduced to avoid unnecessary “intermediate” parameter adaptations, so that multiple consecutive changes are treated “as one”.

In accordance with an exemplary embodiment, instead of updating the protection parameters automatically, a human-supervised procedure may be applied: one of the described methods can be used to determine proper protection parameter values; those are then suggested to a human operator who will then have the choice to accept them (and thus they may be set automatically) or refuse them.

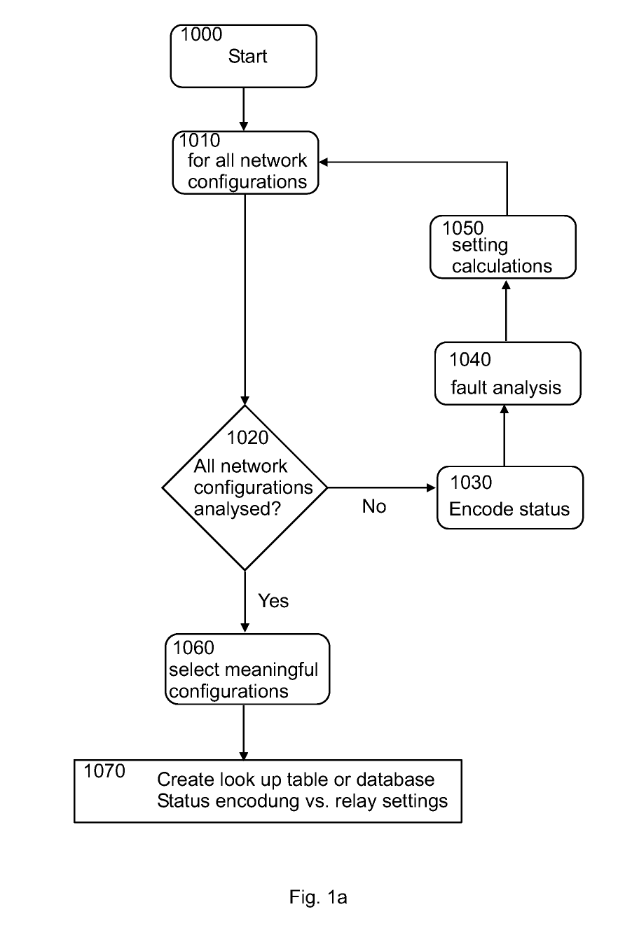

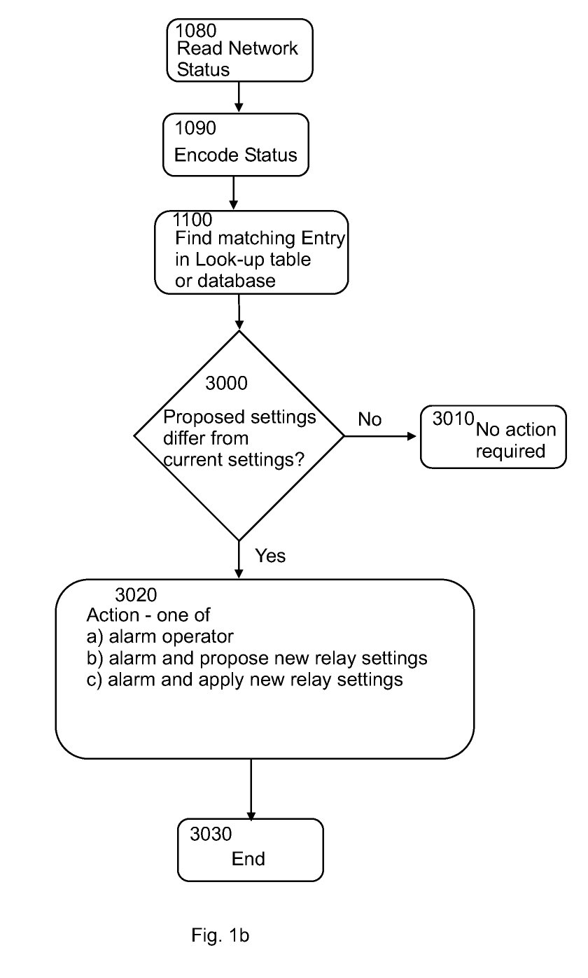

FIG. 1a shows a first portion of a flowchart of an exemplary embodiment of a method according to the present disclosure. In the embodiment shown in FIGS. 1a and 1b, the steps 1000 to 1070 shown in FIG. 1a may be performed at engineering time, e.g. before new switch or circuit breaker has been installed in a network. In the offline-analysis shown in FIG. 1a, for all network configurations the status is encoded, a fault analysis is performed and subsequently the settings for an IED or the like is calculated. The status of a network may include the configuration of a switch, e.g. if a switch or a circuit breaker is open or closed, the configuration of an energy source, the configuration of a load, and/or the like. For example, the power produced by a distributed energy source like a photovoltaic plant may vary during the day, weather and/or the year. Each of these status configurations may be in an embodiment encoded in Boolean clauses (see step 1030). In a further embodiment, another suitable logic may be used.

In a further step 1040, a fault analysis takes place. The fault analysis may include all predictable faults in the network, e.g. short circuits, faults of a load and/or the like.

In a further step 1050, the best settings for all IEDs are calculated. In accordance with an exemplary embodiment, the settings may be used that provide the best availability of electrical power to the loads.

After the settings for all network configurations are calculated, in accordance with an exemplary embodiment, only the meaningful configurations are selected. This step may be omitted in some embodiments. For instance, configurations that have no influence on the behavior of the protection system may be discarded. In a further embodiment, only the settings for the meaningful configurations are calculated, e.g., the loop shown in FIG. 1a with steps 1010, 1020, 1030, 1040 and 1050 would be only performed for the meaningful configurations. That may reduce the amount of calculations.

In step 1070, all configurations are stored in a lookup table or a database. Any other suitable storing scheme may be used for storing the configurations. For example, the configurations may be stored centrally in a master server that is in connection with all IEDs. In another embodiment, each IEDs stores for each network configuration only the parameters or settings for its use.

In the following it will be explained, in an exemplary embodiment, how the settings or parameters are adapted during operation of the network. This is explained with respect to FIG. 1b.

During network operation, the starting of the method steps shown in FIG. 1b may be event based, e.g. after a switch position has changed, or periodically, and/or manually. Then, in step 1080, the network status is read. For example, all positions of the switches may be read (e.g., determined). In the subsequent step 1090 the network status is encoded. The encoding may include not only switch position information, but also information about the weather, the power provided by distributed energy resources, and/or the like.

After encoding the information, the encoded information is used for finding a matching entry in the stored look-up table or in a database (step 1100). The settings or parameters for the IEDs are loaded.

In accordance with an exemplary embodiment, in step 3000, these settings or parameters are compared the current settings in the IEDs. If, for example, the proposed settings do not differ from the current settings, no action is required. In case the proposed new settings or parameters differ from the current settings, in step 3020 either an operator is alarmed, an operator is alarmed and new settings or parameters are proposed for the IEDs, or an operator is alarmed and the settings or parameters are set automatically in the IEDs. In a further embodiment, the new settings may be also applied without alarm.

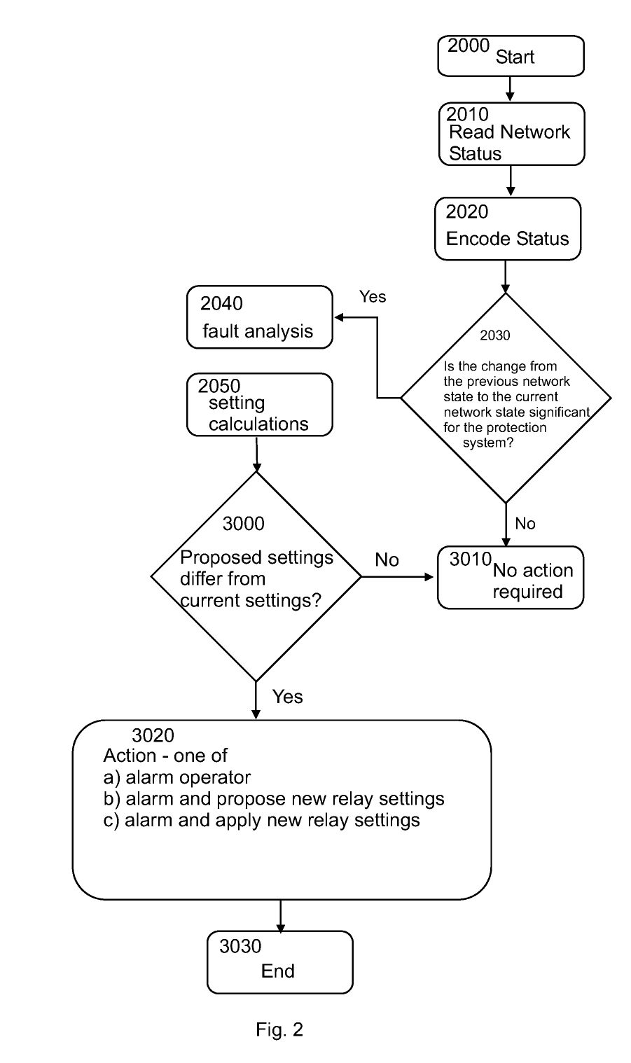

FIG. 2 shows a flowchart of an exemplary embodiment of a method according to the present disclosure. In the embodiment of FIG. 2, the possible settings or parameters for each IED are not precalculated at engineering time as already mentioned with respect to the embodiment of the method shown in FIGS. 1a and 1b, but the possible settings or parameters are calculated during the operation of a network after a new network status has been detected or the beginning of the method may have been triggered otherwise.

During network operation, the starting of the method steps shown in FIG. 2 may be event based, e.g. after a switch position has changed, or periodically, and/or manually. Then, in step 2010, the network status is read (e.g., determined). For example, all positions of the switches may be read. In the subsequent step 2020, the network status is encoded. In accordance with an exemplary embodiment, the network status may be encoded into a Boolean logic. The encoding may include not only switch position information, but also information about the weather, the power delivered by distributed energy resources, and/or the like. In another embodiment, step 2020 is omitted.

In step 2030, the current network status is compared with the previous network status. For example, it is determined if the change in the network status is significant for the protection system. If the network configuration or status change will not influence the behavior of the protection system, the costly analysis of the faults may be avoided. In another exemplary embodiment, the compare step can be omitted and the fault analysis is always performed.

Steps 2040 and 2050 correspond to the steps 1040 and 1050 of the embodiment shown in FIG. 1a. For instance, in these steps the possible faults in the network are analyzed and the settings or parameters of the IEDs or relays are computed.

Steps 3000 to 3030 correspond to the steps 3000 to 3030 of the embodiment shown in FIG. 1b such that for the sake of simplicity it is referred to the description of FIG. 1b.

### First Practical Example

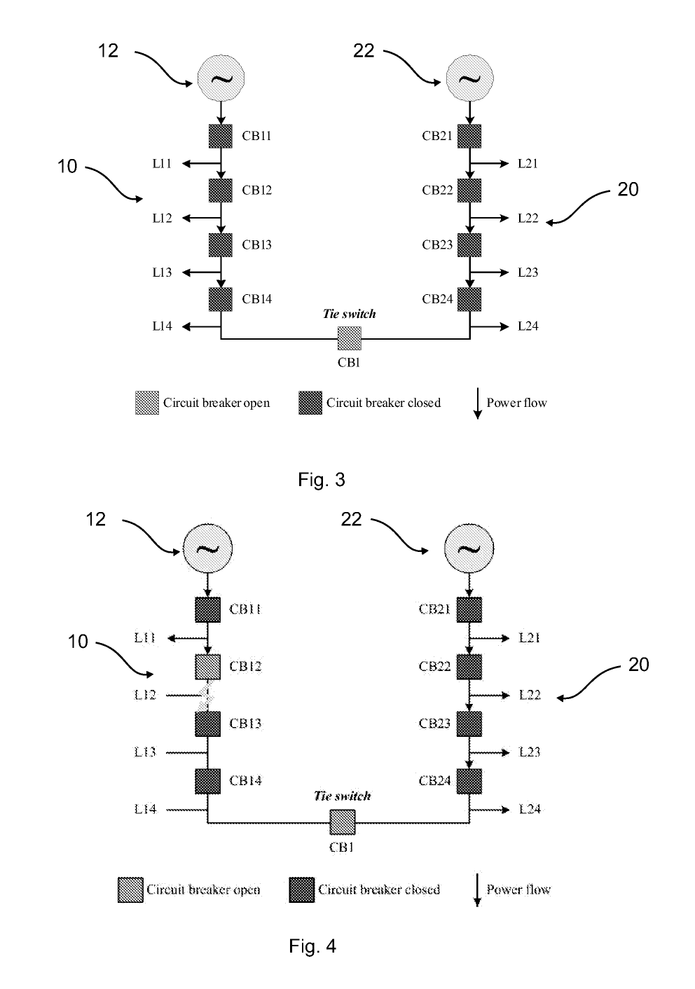

In FIG. 3, an embodiment shows an example from the feeder automation. FIG. 3 shows two feeders 10, 20 with a normally open switch (tie switch) CB1 in between. An over-current protection is installed at a level of each circuit breaker CB1, CB11, CB12, CB13, CB14, CB21, CB22, CB23 and CB24.

The first feeder 10 and the second feeder 20 are powered by different sources 12, 22 and separated by a normally open switch (or tie switch) CB1. Further, FIG. 3 shows multiple loads L11, L12, L13, L14, L21, L22, L23 and L24. Protection of the network is ensured by over-current protection functions running in IEDs at the level of each circuit breaker CB11, CB12, CB13, CB14, CB21, CB22, CB23 and CB24. In the present example, switches are circuit breakers in order to simplify the discussion.

As it is shown in FIG. 4, a fault may occur on the line towards the load L12. If properly engineered (e.g., if the protection parameters of all over-current protection functions are properly set), the over-current protection function at the level of circuit breaker CB12 may initiate a trip of circuit breaker CB12. As a consequence, loads L13 and L14 are not powered anymore, as shown in FIG. 4.

A manual or automatic feeder restoration algorithm may restore the power to loads L13 and L14 as follows, in case that the power source 22 for the second feeder 20 has enough capacity):

1. Fault isolation: open circuit breaker CB13.
2. Power restoration to the loads L13 and L14 by closing the tie switch or circuit breaker CB1.

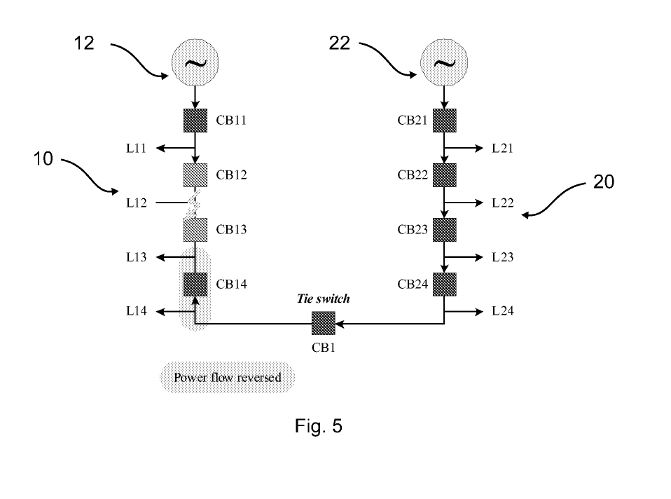

Thus, after the situation depicted in FIG. 4, the feeder restoration algorithm will therefore isolate the fault in the load L12 by opening circuit breaker CB13 and then closing the tie switch CB1 as shown in FIG. 5. Power is thus restored to loads L13 and L14 via the second feeder 20. However, as a consequence, the power flow through circuit breaker CB14 is reversed compared to the situation before the fault. Therefore, according to an exemplary embodiment, the time delay setting for over-current protection in circuit breaker CB14 may be updated—it may “react” faster than the ones in CB1 (and thus circuit breaker CB24). In other words, if both the over-current functions at circuit breaker CB14 and at circuit breaker CB1 detect a fault, the one at circuit breaker CB14 should react faster. Therefore, in order to ensure the selectivity criterion, the over-current protection setting at circuit breaker CB14 level should then be set to a lower time delay (and/or different tripping current) than the one in circuit breaker or tie switch CB1 and circuit breaker CB24.

According to an exemplary embodiment, an IED may detect that the over-current protection function in circuit breaker CB14 may be adapted without human intervention (or a centralized entity). By listening to GOOSE (Generic Object Oriented Substation Events) messages sent by circuit breaker CB13 and tie switch CB1, the IED can determine that power flow through circuit breaker CB14 is reversed and thus that the current settings of the over-current protection function for circuit breaker CB14 are not properly defined (not selective) anymore.

In another exemplary embodiment, the IED containing the over-current protection function for circuit breaker CB14 has power flow detection mechanisms available, such that this information is enough to trigger the adaptation need of the over-current protection's parameters.

At this point, in accordance with an exemplary embodiment, either an alarm may be raised to inform the operator (e.g., through the use of a dedicated GGIO logical node if IEC 61850 is being used), who is then in charge to change protection parameters (for instance, in a typical embodiment by changing the active setting group), or the settings may be, in accordance with an exemplary embodiment, updated automatically.

In accordance with an exemplary embodiment, upon detection that parameters for the over-current protection need to be adapted, the parameters can be updated automatically.

In accordance with an exemplary embodiment, the settings for all different network topologies are pre-computed and stored internally in a non-volatile, non-transitory computer-readable recording medium of the IED. For example, Boolean logic on the position of relevant switches may be used to select and apply the correct protection setting case. In the example of FIG. 5, this may be applied for circuit breaker CB14. The use of setting groups is possible if there are enough of them. Otherwise, in another exemplary embodiment, an internal table may be used. Further, the parameters of the over-current protection functions “upstream”, e.g., in direction of the current source 22, namely the over-current protection functions for circuit breakers CB1, CB24, CB23, CB22, and CB21, may also need to be updated if the parameters for circuit breaker CB14 cannot be set to a lower delay value than the others. This means the parameters of the circuit breaker CB14 may be set such that circuit breaker “reacts” faster than circuit breaker CB1, which reacts faster than circuit breaker CB24, which reacts faster than circuit breaker CB23, which reacts faster than circuit breaker CB22, which reacts faster than circuit breaker CB21. In accordance with an exemplary embodiment, the IED(s) holding these protection functions may also listen to the changes in topology and react independently.

In accordance with an exemplary embodiment, the IED of the circuit breaker CB14 has an internal model of the power network or the network topology, and the positions of the relevant switches (in a typical embodiment, all circuit breakers depicted in FIGS. 3 to 5) and re-computes the adequate settings automatically. This means that the parameters or protection settings may not be looked up in a table, but are analyzed online. Note that the over-current protection functions of the circuit breakers CB1, CB24, CB23, CB22, and CB21 situated “upstream” may be updated in a similar or independent fashion.

In accordance with an exemplary embodiment, which may be combined with other embodiments described herein, a centralized computing device, or master (e.g., a station computer, a gateway with computing capabilities), with communication to all switches CB1, CB11, CB12, CB13, CB14, CB21, CB22, CB23 and CB24 in both feeders 10, 20 performs the parameter setting automatically by remote commands to all the involved IEDs. In an exemplary embodiment, the centralized computer either has pre-computed solutions for each topology case, e.g., each topology case is stored in a data base or a table. The parameters for each circuit breaker CB1, CB11, CB12, CB13, CB14, CB21, CB22, CB23 and CB24 are then sent to the respective IEDs. In another exemplary embodiment, the centralized computing device or master re-computes the settings for all protection functions so that they satisfy the selectivity criterion. Such a (semi-centralized) solution can be performed, for example, when IEDs have limited memory and/or computing resources. In a further exemplary embodiment, wherein no single computing device is controlling (e.g. with direct communication to) all involved IEDs, parameter setting can be distributed over several masters (for example with possible coordination among them to ensure time-coordinated setting).

### Second Practical Example

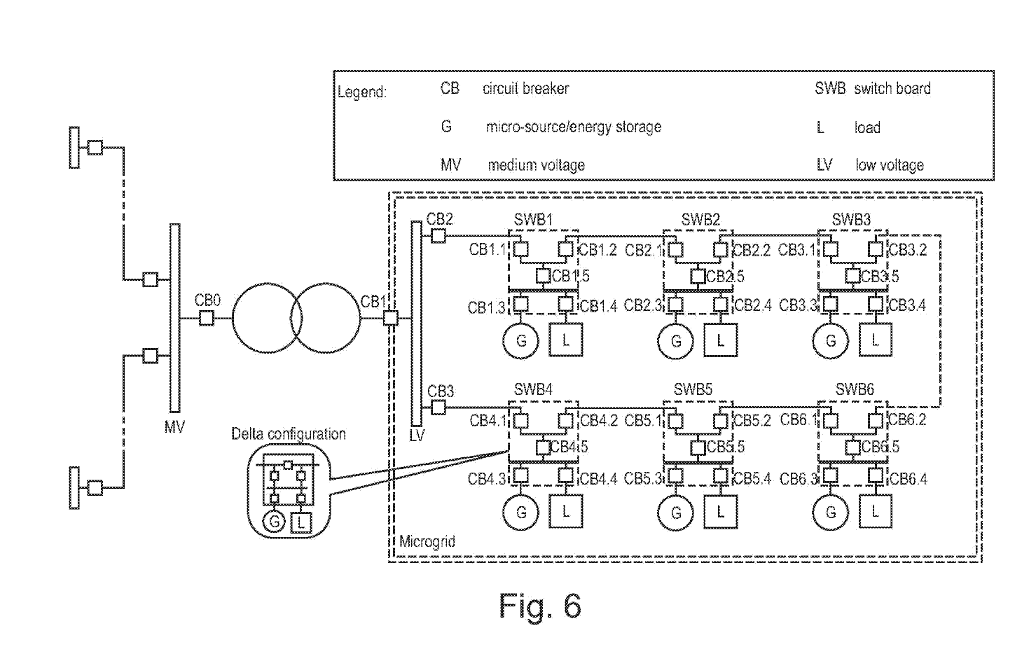

In the following, embodiments with distributed energy resources are described. As compared to the network shown in FIGS. 3 to 5, the distribution network shown FIG. 6 includes at each feeder several distributed energy resources (DER) units that are marked with G. The DER may be, for example, a micro-source or an energy storage source. The microgrid is connected to the main medium voltage (MV) grid when the circuit breaker (CB) CB1 is closed. The circuit breakers CB2 and CB3 are normally closed and circuit breakers CB 3.2 and 6.2 are normally opened. Therefore, the network shown in FIG. 6 includes a low voltage (LV) part with a first feeder with circuit breaker CB2 and switch boards SWB1, SWB2 and SWB2 and a second feeder with circuit breaker CB3 and switch boards SWB3, SWB5 and SWB6.

A protection of distribution grid where feeders are radial with loads tapped-off along feeder sections can be designed assuming a unidirectional power flow and is based on OC relays with time-current discriminating capabilities. OC protection detects the fault from a high value of the fault current flowing downwards. In modern digital relays, a tripping short-circuit current can be set in a wide range (e.g., 0.6-15*CB rated current). If a measured current is above the tripping setting, the relay operates to trip the CB on the line with a delay defined by a coordination study and compatible with a locking strategy used (no locking, fixed hierarchical locking, directional hierarchical locking).

In accordance with an exemplary embodiment, distribution grids may include one or more DERs such as solar or photovaltaic (PV) panels, wind and micro-gas turbines, fuel cells, etc. Generally, most of the micro-sources and energy storage devices are not suitable for supplying power directly to the grid and may be interfaced to the grid with power electronics (PE).

A use of PE interfaces may lead to a number of challenges in microgrid's protection, especially in the islanded mode.

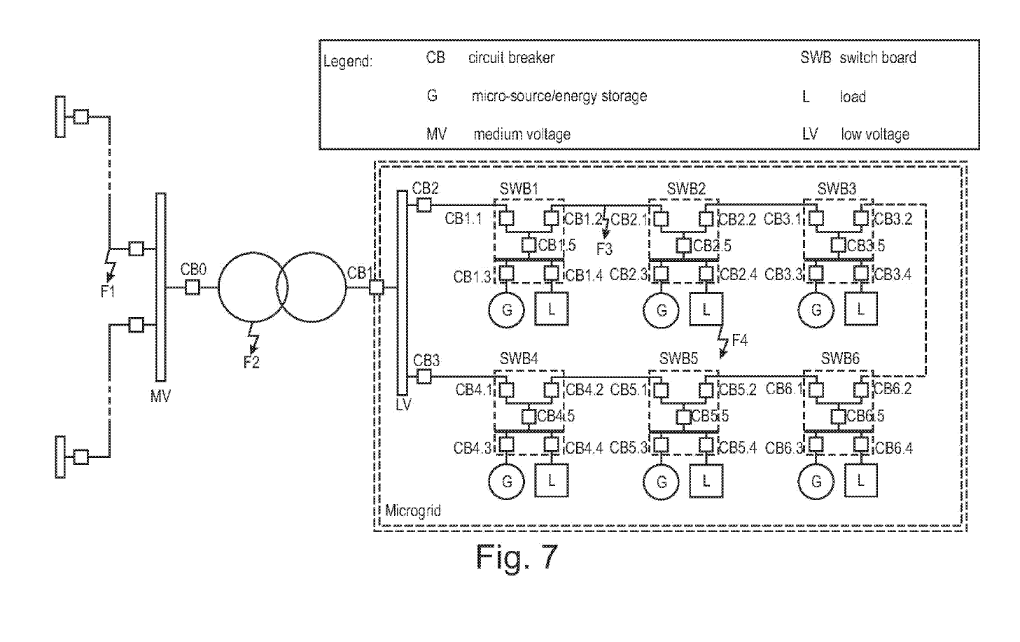

FIG. 7 represents the same microgrid as shown in FIG. 6 with two feeders connected to the LV bus and to the MV bus via a distribution transformer. Each feeder has three switchboards SWB1, SWB2, SWB3, SWB4, SWB5, SWB6. Each switchboard may have a star or delta configuration and connects distributed energy resources (DER), in particular marked with G in the drawings, and load L to the feeder. In FIG. 9, two external (F1, F2) and two internal (F3, F4) microgrid faults are shown. All low voltage circuit breakers CB1, CB2, CB3, CB1.1, CB1.2, CB1.3, CB1.4, CB1.5, CB2.1, CB2.2, CB2.3, CB2.4, CB2.5, CB3.1, CB3.2, CB3.3, CB3.4, CB2.5, CB4.1, CB4.2, CB4.3, CB4.4, CB4.5, CB5.1, CB5.2, CB5.3, CB5.4, CB5.5, CB6.1, CB6.2, CB6.3, CB6.4 CB6.5 may have different ratings but in this exemplary embodiment are equipped with an over current (OC) protection and used for segmenting the microgrid, in particular the distribution LV feeder.

In general, protection issues in microgrid can be divided in two groups regarding a microgrid operating state. Table 1 shows Major Classes of Microgrid Protection problems. Table 1 also shows an importance of “3S” (sensitivity, selectivity and speed) requirements for different cases, which provides a basis for design criteria of a microgrid protection system.

Fault location

| | External faults (main grid) | | | |
|---|---|---|---|---|
| Operating | MV feeder, | Distribution | Internal faults (microgrid) | |
| mode | bus-bar (F1) | transformer (F2) | LV feeder (F3) | LV consumer (F4) |
| Grid | Fault is | Fault is | Disconnect a smallest | Faulty load is |
| connected | normally | normally | portion of microgrid | isolated by |
| (CB1 is | managed by | managed by | (CB1.2 and CB2.1). | CB2.4 or fuse. |
| closed) | MV system. | MV system | CB1.2 is opened by | In case of no |
| | Microgrid | (CB0). CB1 is | fault current from the | tripping the |
| | isolation by CBI | opened by | grid (high level). | SWB is isolated |
| | in case of no | “follow-me” | Low level of a | by CB2.5 and |
| | MV protection | function of | reversed fault current | local DER is |
| | tripping. | CB0. In case if | from feeder's end | cut-off. No |
| | Possible fault | communication | may cause sensitivity | sensitivity or |
| | sensitivity | fails then | problems for CB2.1*. | selectivity |
| | problems for | possible fault | In this case a “follow- | problems. |
| | CB1*. | sensitivity | me” function of CB1.2 | |
| | | problem for | can to open CB2.1. In | |
| | | CB1*. | case if communication fails | |
| | | | then possible fault | |
| | | | sensitivity problems | |
| | | | for CB2.1*. | |
| | | | Disconnect a smallest | Faulty load is |
| | | | portion of microgrid | isolated by |
| | | | (CB1.2 and CB2.1). | CB2.4 or fuse. |
| | | | CB1.2 is opened by | In case of no |
| | | | fault current from the | tripping the |
| | | | grid (high level). | SWB is isolated |
| | | | Low level of a | by CB2.5 and |
| | | | reversed fault current | local DER is |
| | | | from feeder's end | cut-off. |
| | | | may cause sensitivity | Sensitivity or |
| | | | problems for CB2.1*. | selectivity |
| | | | In this case a “follow- | problems no |
| | | | me” function of CB1.2 | likely. |
| | | | can to open CB2.1. In | |
| | | | case if communication fails | |
| | | | then possible fault | |
| | | | sensitivity problems | |
| | | | for CB2.1*. | |

*low fault current contributin from the Microgrid in case of DER with PE interfaces.

### Grid Connected—External Fault (F1, F2)

In case of first fault F1, a main grid (MV) protection may clear the fault. If sensitive loads are presented in microgrid, the microgrid may be isolated by circuit breaker CB1 as fast as 70 ms (depending on a voltage sag in the microgrid). Also, the microgrid may be isolated from the main grid by circuit breaker CB1 in case of no medium voltage (MV) protection tripping.

A detection of fault F1 with a generic over current (OC) relay can be problematic in case most of the micro-sources in the microgrid are connected by means of PE interfaces which have built-in fault current limitation (e.g., there is no significant rise in current passing through circuit breaker CB1). They are generally capable of supplying 1.1-1.2*IDERrated to a fault, unless the converters are specifically designed to provide high fault currents. These numbers are much lower than a short-circuit current supplied by the main grid. A directional over current relay in circuit breaker CB1 may be only a feasible solution if current is used for the fault detection. In order to increase relay sensitivity a setting for a reverse current is defined as a sum of fault current contributions from all connected distributed energy resources (DER) (1). This value will vary in case of a large number of different types of DER. Thus, the setting has to be continuously monitored and adapted when microgrid generation undergoes considerable change (number and type of connected DER).

Alternatively, voltage sag (magnitude and duration) and/or system frequency (instantaneous value and rate of change) may be used as other indicators for a tripping of circuit breaker CB1. Some distribution network operators (DNO) may require a microgrid to stay connected and supply reactive power to the fault up to several seconds.

In case of fault F2, a distribution transformer OC protection clears the fault by opening circuit breaker CB0. Circuit breaker CB1 is opened simultaneously by a “follow-me” function (hardware lock) of circuit breaker CB0. In case of hardware lock failure a possible fault sensitivity problem can arise as in the case of fault F1. Typical solutions are similar to fault F1 case (directional adaptive OC protection, under-voltage and under-frequency protection).

### Grid Connected—Fault in the Microgrid (F3)

In the case of fault F3, a short-circuit current is supplied to the fault from two sides, namely from the medium voltage (MV) distribution grid, shown on the left side of FIG. 7, via switch board SWB1 and DER at switch boards SWB2 and SWB3. The short-circuit current magnitude through circuit breaker CB1.2 will depend on the status of circuit breaker CB1.3. In case of fault F3 a microgrid protection may disconnect a smallest possible portion of the LV feeder by circuit breaker CB1.2 and circuit breaker CB2.1. Circuit breaker CB1.2 is opened due to a high level of short-circuit current supplied by the main MV grid. If circuit breaker CB1.2 fails to trip, the fault F3 may be cleared by circuit breaker CB1.1 which is a backup protection for circuit breaker CB1.2. However, a sensitivity of OC protection relay in circuit breaker CB1.1 can be potentially disturbed in case a large synchronous DER (e.g. diesel generator) is installed and switched-on in switch board SWB1 (i.e. between circuit breaker CB1.1 and the fault F3). In this case, the fault current passing through the circuit breaker CB1.1 in case with DER will be smaller than in case without DER. In other words, if the DER at SWB1 is capable of supplying high fault current (e.g. synchronous generator) and is connected (circuit breaker CB1.3 is closed), then the fault current will be higher than in the case when DER is disconnected (circuit breaker CB1.3 is open). This effect may be known as protection blinding (the larger the synchronous DER the greater is the effect) and may result in a delayed circuit breaker CB1.1 tripping because of the fault current transition from a definite-time part to an inverse-time part of relay tripping characteristic. A delayed fault tripping will lead to an unnecessary disconnection of local synchronous DER (usually low power diesel generators have very low inertia and can lose synchronism in case of slow clearing faults). This issue can be solved by a proper coordination of microgrid and DER protection systems. Another option is adapting protection settings with regard to current operating conditions (DER status).

But in case CB1.2 failed to open, then circuit breaker CB2 may open. However, if DER at switch board SWB1 is connected (circuit breaker CB1.3 is closed) and has a relatively high disconnection time delay, the fault current through circuit breaker CB2 will be lower (e.g. 70-90% of the case without DER). Because of the DER's contribution to the short-circuit current, the voltage drop over the feeder section between the DER and the fault increases, which results in a lower fault current from the grid. This may result in a delayed circuit breaker CB2 tripping (because the fault current is moved from the instantaneous to the inverse-time part of the relay tripping characteristic) and may lead to an unnecessary DER disconnection in switch boards SWB4, SWB5 and SWB6.

If, as likely, circuit breaker CB1.2 operates faster than circuit breaker CB2.1, it will island a part of the microgrid, including switch boards SWB2 and SWB3, which will be connected to the fault F3. If it is possible to balance generation and load in the islanded segment of the microgrid, e.g. micro-sources or DERs are capable to supply loads directly or after load shedding, it is expedient to isolate that group of micro-sources and loads from the fault F3 by opening circuit breaker CB2.1 and possibly closing circuit breaker CB3.2 to 6.2.

However, a reversed and low level short circuit current in case of DER with PE interfaces will cause a sensitivity problem for circuit breaker CB2.1, similar to the one described above in case of the fault F1. Here, sensitivity of the protection system without directional OC protection is critical because short-circuit current changes direction and cannot reach the level of short circuit current provided by the MV grid. Possible solutions include directional adaptive OC protection and a “follow-me” function of circuit breaker CB1.2 which opens circuit breaker CB2.1 (in case of communication failure possible sensitivity problems for circuit breaker CB2.1). Settings of directional protection may take into account the number and type of available DER in the islanded segment. In that case, directional OC relay settings in the direction to the MV grid are considerably lower than in the direction from the MV grid.

### Grid Connected—Fault in the End-Consumer Site (F4)

In case of fault F4 a high short-circuit current is supplied to the fault from the main grid together with a contribution from DER and will lead to a tripping of circuit breaker CB2.4. Frequently, there is a fuse instead of a circuit breaker which is rated in such a way that a shortest possible fault isolation time is guaranteed. In case of no tripping, the switch board SWB2 is isolated by circuit breaker CB2.5 and local DER is cut-off. No sensitivity or selectivity problems are foreseen in this scenario.

### Islanded Mode—Fault in the Microgrid (F3)

The microgrid operates in the islanded mode when it is intentionally disconnected from the main MV grid by circuit breaker CB1 (full microgrid) or a circuit breaker along the low voltage (LV) feeder (a segment of the microgrid). This operating mode is characterized by an absence of a high level of short-circuit current supplied by the main grid. Generic OC relays would be replaced by directional OC relays because fault currents flow from both directions to the fault F3.

If circuit breaker CB1.2 and circuit breaker CB2.1 use setting groups chosen for the grid connected mode, they will have a selectivity problem to detect the fault F4 and trip within acceptable time frame in case of DER with PE interfaces (the fault current could shift from a definite-time part to an inverse-time part of the relay tripping characteristic). For instance, one needs to care about a fault if there is no fault current for the safety of people. Further, permanent faults may spread out and destroy more equipment.

According to an exemplary embodiment, the above issues may be addressed by:

Installing a source of high short-circuit current (e.g. a flywheel or a super-capacitor) to trip CBs/blow fuses with settings/ratings for the grid connected mode. However, a short-circuit handling capability of PE interfaces can be increased only by increasing the respective power rating which leads to higher investment cost.

Installing an adaptive microgrid protection using on-line data on microgrid topology and status of available micro-sources/loads.

### Islanded Mode—Fault in the End-Consumer Site (F4)

In case of fault F4, a low short-circuit current is supplied to the fault from the local DER. There is no grid contribution. However, circuit breaker CB2.4 settings selected for the main grid connected mode are just slightly higher than rated load current. It assures that the end-customer site will be disconnected even if only DERs with power electronics (PE) interfaces are available in the microgrid. In case of no tripping the switch board switch board SWB2 may be isolated by circuit breaker CB2.5 using directional OC relay. Similar to the grid connected mode, there are no sensitivity or selectivity problems foreseen in the islanded mode for the fault in the end-consumer site.

In the following, an exemplary embodiment is described wherein an impact of micro-sources (DERs) and microgrid configuration on the relay performance is anticipated and accordingly the relay settings are changed to ensure that the whole microgrid is protected at all times. Adaptive protection may be defined in an embodiment as “an online activity that modifies the preferred protective response to a change in system conditions or requirements in a timely manner by means of externally generated signals or control action”.

For example, in case the fault F3 is detected and successfully isolated by circuit breaker CB2.1, the switch boards SWB2 and SWB3 will operate as an electrical island known as microgrid. In this configuration, there is no high short-circuit current from the MV grid. The OC protection may be upgraded/changed to directional OC relays because in the case of a fault short-circuit, currents will flow from both directions to the fault. In case circuit breakers use setting groups from the grid connected mode they will not be able to detect the fault and trip instantaneously if most DERs have power electronics (PE) interfaces with a limited fault current contribution. In extreme cases, the fault current contribution from DERs can only reach 1.1-1.2 times the rated current. Here, again only adaptive protection can guarantee a detection and selective operation of relays. When switch boards SWB2 and SWB3 are isolated and fault is happening between switch boards SWB2 and SWB3 and if both nodes can maintain a balance between generation and consumption then protection settings of current breaker CB2.2 may be modified. If this will not be done, then current breakers CB2.2 and CB3.1 will open after a considerable delay and DERs in switch boards SWB2 and SWB3 will be disconnected and as a result the load in switch boards SWB2 and SWB3 will be interrupted.

In accordance with an exemplary embodiment, in a first step it may be detected that the protection parameters need to be adapted. For example, triggering events may be used for that purpose. Triggering events for updating protection settings of different IEDs/electronic releases in a distribution feeder with DER can include: Connection/disconnection of DER, Topology change (as in the previous example) including islanded mode, and/or the like.

In accordance with an exemplary embodiment, numerical directional OC relays may be used. Fuses or electro-mechanical and standard solid state relays are especially for selectivity holding inapplicable, because they do not provide flexibility for setting of tripping characteristics as well as no current direction sensitivity feature.

In accordance with an exemplary embodiment, which may be combined with other embodiments described herein, numerical directional OC relays may dispose of possibility for different tripping characteristics (several settings groups) which may be parameterized.

In another exemplary embodiment, which may be combined with other embodiments disclosed herein, new or existing communication infrastructure (e.g. twisted pair, power line) and standard communication protocols (for example, Modbus or IEC61850) are used such that individual relays can communicate and exchange information with a central computer or between different individual relays fast and reliably to guarantee a required application performance.

In accordance with an exemplary embodiment, communication between circuit breakers CB0, CB1, CB2, CB3, CB1.1, CB1.2, CB1.3, CB1.4, CB1.5, CB2.1, CB2.2, CB2.3, CB2.4, CB2.5, CB3.1, CB3.2, CB3.3, CB3.4, CB3.5, CB4.1, CB4.2, CB4.3, CB4.4, CB4.5, CB5.1, CB5.2, CB5.3, CB5.4, CB5.5, CB6.1, CB6.2, CB6.3, CB6.4 CB6.5, and central unit provides an opportunity to detect a need for a modification of protection settings of directional OC relays without human intervention.

In case DER in switch board SWB1 is switched on, i.e. circuit breaker CB1.3 is closed, and communicates its status to a central protection coordination unit/other circuit breakers which can determine that fault current through circuit breaker CB2 decreases and fault current through circuit breaker CB1.2 increases and that the current settings of OC protection relays are not properly defined anymore.

In a further step, the protection settings may be updated, e.g., automatically. Upon detection that parameters for the OC protection need to be adapted, the parameters can be updated automatically. This can be achieved in different ways:

In accordance with an exemplary embodiment, the settings for all relevant combinations of network topologies and position of DERs are pre-computed and stored internally in the IEDs of the circuit breakers (each circuit breaker in the low voltage grid).

In another exemplary embodiment, the IED has an internal model of the power network and the positions of the relevant switches (feeder and DERs). In this case, the IED can re-compute all circuit breakers depicted in FIG. 6 and adapt the adequate settings automatically.

In a further exemplary embodiment, a centralized computing device, or master (e.g., a station computer, a gateway with computing capabilities), with communication to all switches or circuit breakers does the parameter setting automatically by remote commands to all the involved IEDs. The centralized computer may have pre-computed solutions for each topology case (feeder and/or DERs) or may re-compute the settings for all protection functions so that they satisfy the selectivity criterion. Such a (semi-centralized) solution can be preferred when IEDs have limited memory and/or computing resources. In accordance with an exemplary embodiment, which may be combined with other embodiments described herein, wherein no single computing device is controlling (with direct communication to) all involved IEDs, the parameter setting can be distributed over several masters (with possible coordination among them to ensure time-coordinated setting). In another exemplary embodiment, which may be combined with other embodiments, in the islanded mode a calculation can be done on a central computer if it can communicate with the islanded part of the distribution grid, or directly at the islanded switch boards if they have enough computing capacity.

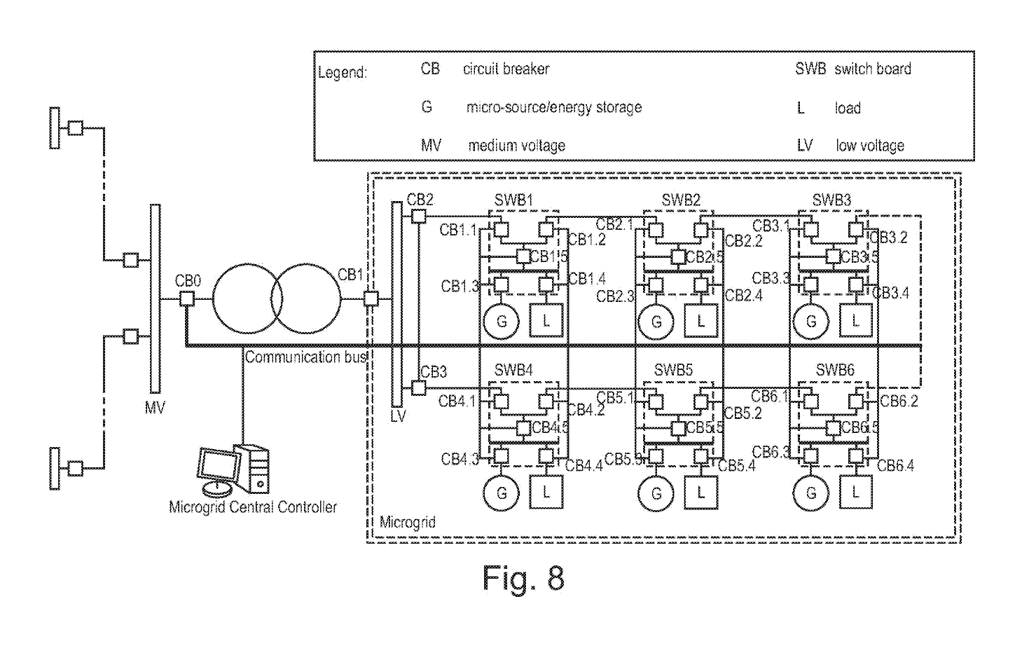

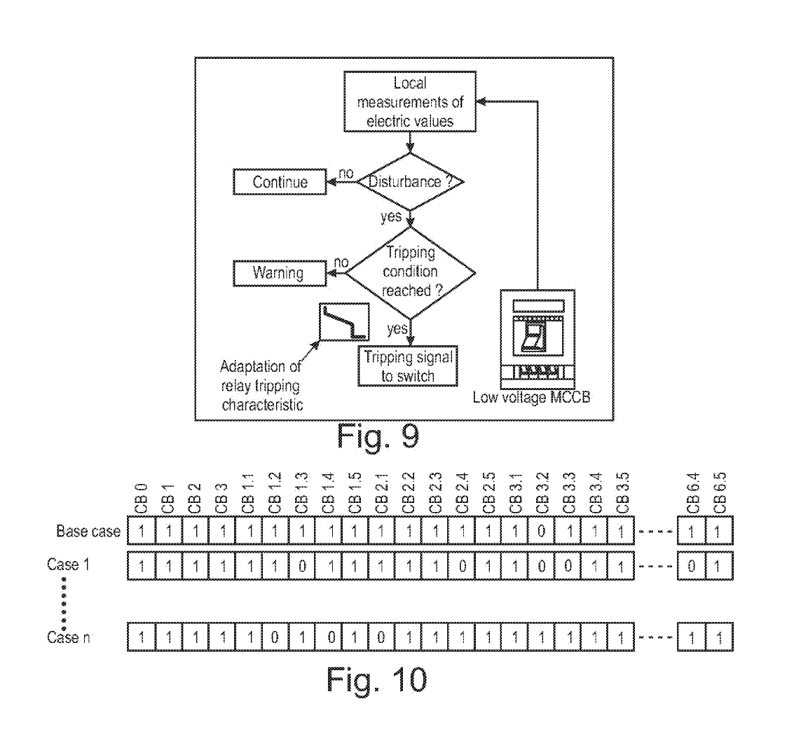

In FIG. 8, an exemplary embodiment of a centralized adaptive protection system is shown. There is a microgrid central controller (MCC) and communication system in addition to elements shown in FIGS. 6 and 7.

Electronics make each circuit breaker CB0, CB1, CB2, CB3, CB1.1, CB1.2, CB1.3, CB1.4, CB1.5, CB2.1, CB2.2, CB2.3, CB2.4, CB2.5, CB3.1, CB3.2, CB3.3, CB3.4, CB2.5, CB4.1, CB4.2, CB4.3, CB4.4, CB4.5, CB5.1, CB5.2, CB5.3, CB5.4, CB5.5, CB6.1, CB6.2, CB6.3, CB6.4 CB6.5 with an integrated directional OC relay capable of exchanging information with microgrid central controller MCC. For example, in FIG. 8 circuit breakers CB0, CB1, CB2, CB3, CB1.1, CB1.2, CB1.3, CB1.4, CB1.5, CB2.1, CB2.2, CB2.3, CB2.4, CB2.5, CB3.1, CB3.2, CB3.3, CB3.4, CB2.5, CB4.1, CB4.2, CB4.3, CB4.4, CB4.5, CB5.1, CB5.2, CB5.3, CB5.4, CB5.5, CB6.1, CB6.2, CB6.3, CB6.4 CB6.5 are connected to a serial communication bus RS485 and use standard industrial communication protocol Modbus. By polling individual relays, the MCC can read data (electrical values, status) from circuit breakers and if necessary modify relay settings (e.g., tripping characteristics). Other communication protocols and buses may be used in other embodiments.

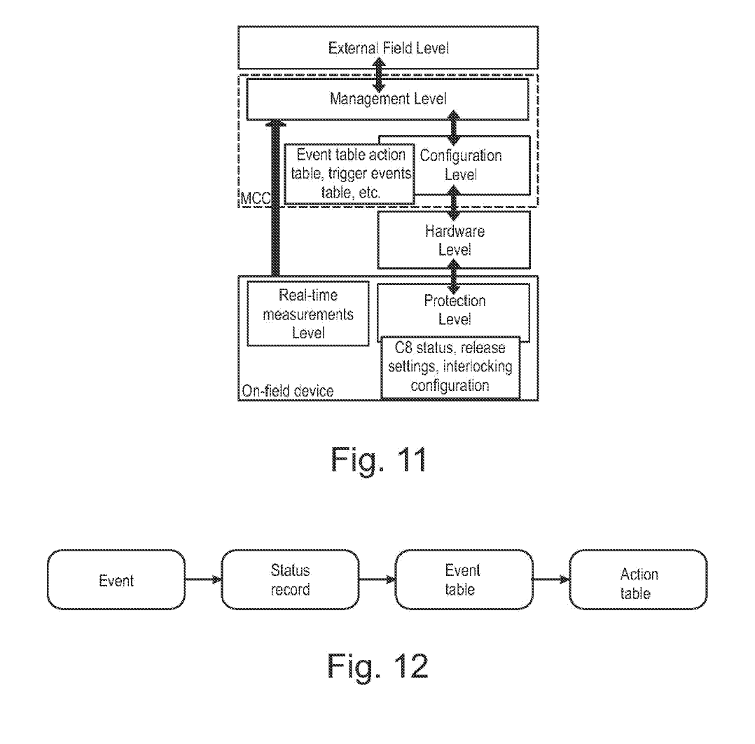

Each individual relay takes a tripping decision locally (independently of MCC) and performs in accordance with the exemplary embodiment illustrated in FIG. 9. FIG. 9 shows a local protection function inside a circuit breaker. In case an abnormal situation is detected, a tripping condition is checked. For example, a measured current in a specific direction is compared with the actual relay setting. If the tripping condition is reached, a circuit breaker is open. FIG. 11 shows an example with respect to a low voltage circuit breaker. The same may also apply, in some embodiments, to medium voltage or high voltage circuit breakers.

The adaptive protection system according to the exemplary embodiment shown in FIG. 8 is to maintain settings of each relay with regard to a current state of the microgrid. It is effectuated by a special module in MCC which is responsible for a periodic check and update of relay settings of the circuit breakers CB0, CB1, CB2, CB3, CB1.1, CB1.2, CB1.3, CB1.4, CB1.5, CB2.1, CB2.2, CB2.3, CB2.4, CB2.5, CB3.1, CB3.2, CB3.3, CB3.4, CB2.5, CB4.1, CB4.2, CB4.3, CB4.4, CB4.5, CB5.1, CB5.2, CB5.3, CB5.4, CB5.5, CB6.1, CB6.2, CB6.3, CB6.4 CB6.5. In accordance with an exemplary embodiment, the module may include components, namely a pre-calculated information during off-line fault analysis of a given microgrid, and an on-line operating block.

### Offline Analysis

A set of meaningful microgrid configurations as well as feeding-in states of DERs (on/off) is created for off-line fault analysis and is called an event table. For example, each record in the event table has a number of elements equal to a number of monitored CBs in the microgrid and is binary encoded, e.g., element=1 if a corresponding CB is closed and 0 if it is open. FIG. 12 shows an exemplary embodiment of the structure of an event table. Other embodiments may also be used. For example, a database may be used. Next, fault currents passing through all monitored circuit breakers are estimated by simulating short-circuits (3-phase, phase-to-ground, etc.) in different locations of the protected microgrid at a time. During repetitive short-circuit calculations, a topology or a status of a single DER is modified between iterations. As different fault locations for different microgrid states are processed the results (the magnitude and direction of fault current seen by each relay) are saved in a specific data structure.

Based on these results, suitable settings for each directional OC relay, e.g., for each IED of a circuit breaker in the microgrid, and for each particular system state are calculated in such a way that guarantees a selective operation of microgrid protection. These settings are grouped into an action table or an action database which has in a typical embodiment the same dimension as the event table.

The event and action tables may be, in an accordance with an exemplary embodiment, part of the configuration level of the microgrid protection and control system or architecture shown in FIG. 11.

External Field Level represents energy market prices, weather forecast, heuristic strategy directives and other utility information.

Management Level includes historic measurements and distribution management system (DMS).

Configuration Level includes a computer or programmable logic circuit (PLC) situated centrally (e.g. at a substation) or locally (e.g. at a switchboard) which is able to detect a system state change and send a required action to hardware level.

Hardware Level transmits a required action from the configuration level to on-field devices by means of a communication network. In the case of a large microgrid, this function can be divided between several local controllers which communicate only selected information to the central unit.

Protection Level may include CB status, release settings, interlocking configuration, etc. Together with Real-time Measurements Level they are sitting inside on-field devices.

### Online Operation

During the on-line operation the MCC monitors the microgrid state by polling individual directional OC relays. This process runs periodically or is triggered by an event (tripping of CB, protection alarm, etc.) and may use the communication system shown in FIG. 8. The microgrid state information received by the MCC is used to construct a status record which may have a similar dimension as a single record in the event table. The status record is used to identify a corresponding entry in the event table. Finally, the algorithm retrieves the pre-calculated relay settings from the corresponding record in the action table and uploads the settings to on-field devices via the communication system. FIG. 12 illustrates phases of an online adaptive protection algorithm with available look-up tables, namely the event and action tables.

The written description uses examples to disclose the disclosure, including the best mode, and also to enable any person skilled in the art to make and use the disclosure. While the disclosure has been described in terms of various specific embodiments, those skilled in the art will recognize that the disclosure can be practiced with modifications within the spirit and scope of the claims. Especially, mutually non-exclusive features of the embodiments described above may be combined with each other. The patentable scope of the disclosure is defined by the claims, and may include other examples that occur to those skilled in the art. Such other examples are intended to be within the scope of the claims.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for adapting at least one set of parameters of at least one Intelligent Electronic Device (IED) of an electrical power network having a plurality of switching devices (CB), the method comprising:
a) reading a present network status of the electrical power network, the present network status including a present status of the plurality of switching devices;
b) deducing, in a processor of a computer processing device, at least one new set of parameter values for the at least one IED based on a simulated fault current induced by at least one simulated network fault under consideration of the present network status and a network topology of the electrical power network; and
c) applying the at least one new set of parameter values to the at least one set of parameters of the at least one IED.

2. The method according to claim 1, wherein in step b) the at least one new set of parameter values is deduced under consideration of forecast information within a predefined horizon.

3. The method according to claim 1, wherein in step b) the at least one new set of parameter values is selected, depending on the present network status, out of a plurality of sets of parameter values.

4. The method according to claim 3, wherein the plurality of sets of parameter values are created by permuting through a plurality of network statuses, and
wherein for each network status
i) at least one network fault is simulated in the electrical power network; and
ii) at least one new set of parameter values for the at least one IED is deduced using a simulated fault current induced by the at least one simulated network fault under considerations of the network status and the network topology.

5. The method according to claim 4, wherein each network status is encoded into logic expressions such that the network status is represented by a vector comprising binary values.

6. The method according to claim 4, wherein steps i) and ii) are created by permuting through substantially all network statuses.

7. The method according to claim 4, comprising:
creating at least one of a table and a database including the network statuses and the set of parameter values corresponding to each network status in the at least one of the table and the database.

8. The method according to claim 1, wherein after step a), the method comprises:
a1) encoding an actual network status into logic expressions such that the network status is represented by a vector comprising binary values.

9. The method according to claim 1, wherein steps a), b), and c) are performed after an event.

10. The method according to claim 1, wherein the network status includes the position of all switches.

11. The method according to claim 1, wherein the network status includes at least one of the status of a distributed energy resource connected to the electrical power network and the status of a load connected to the electrical power network.

12. An apparatus for adapting at least one set of parameters of at least one Intelligent Electronic Device (IED) of an electrical power network having a plurality of switching devices, the apparatus comprising:
a calculation unit configured to simulate at least one network fault in the electrical power network and to deduce at least one set of parameter values for the at least one IED based on a simulated fault current induced by the at least one simulated network fault under consideration of a network status and a network topology of the electrical power network; and
a determining unit configured to determine a present network status of the electrical power network, the network status including a status of the plurality of switching devices,
wherein the calculating unit is configured to deduce a new set of parameter values for the at least one IED depending on the present network status, and
wherein the apparatus is configured to provide the new set of parameter values to the at least one IED for updating the at least one set of parameters of the at least one IED.

13. The method according to claim 4, wherein each network status is encoded into Boolean expressions such that the network status is represented by a vector comprising binary values.

14. The method according to claim 13, comprising:
creating at least one of a table and a database including the network statuses encoded in logic expressions, and the set of parameter values corresponding to each network status in the at least one of the table and the database.

15. The method according to claim 5, comprising:
creating at least one of a table and a database including the network statuses encoded in logic expressions, and the set of parameter values corresponding to each network status in the at least one of the table and the database.

16. The method according to claim 15, wherein after step a), the method comprises:
a1) encoding an actual network status into Boolean expressions such that the network status is represented by a vector comprising binary values.

17. The method according to claim 16, wherein the network status includes the position of all switches.

18. The method according to claim 5, wherein after step a), the method comprises:
a1) encoding an actual network status into Boolean expressions such that the network status is represented by a vector comprising binary values.

19. The method according to claim 7, wherein after step a), the method comprises:
a1) encoding an actual network status into Boolean expressions such that the network status is represented by a vector comprising binary values.

20. The method according to claim 1, wherein step a) is performed periodically.

21. The method according to claim 14, wherein the network status includes at least one of the status of a distributed energy resource connected to the electrical power network and the status of a load connected to the electrical power network.

22. The method according to claim 15, wherein the network status includes at least one of the status of a distributed energy resource connected to the electrical power network and the status of a load connected to the electrical power network.
